(19) United States
(12) Patent Application Publication
(10) Pub. No.: US 2005/0080658 A1
(43) Pub. Date: Apr. 14, 2005

(54) Method and system for determining a near optimal resource schedule

(76) Inventors: Wolf Kohn, Seattle, WA (US); Vladimir Brayman, Mercer Island, WA (US)

Correspondence Address: OLYMPIC PATENT WORKS PLLC, P.O. BOX 4277, SEATTLE, WA, 98104, US

(21) Appl. No.: 10/929,890

(22) Filed: Aug. 30, 2004

Related U.S. Application Data
(63) Continuation-in-part of application No. 10/693,623, filed on Oct. 23, 2003.
(60) Provisional application No. 60/420,920, filed on Oct. 23, 2002.

(51) Int. Cl. G06F 17/60

(52) U.S. Cl. 705/8

(57) ABSTRACT

Method and system for determining a near optimal schedule of resources in linear time by providing an optimal resource ordering scheme that increases customer satisfaction and resource satisfaction and lowers operating costs. The present invention is embodied in a scheduling computer program. The method receives a set of resources and associated resource data. The method determines a resource-rank-function value for each resource, based on the associated resource data. Based on the resource-rank-function value associated with each resource, each resource is rank ordered. For each resource, the method determines a set of candidate shifts, based on the associated resource data. The method determines a weight value for the candidate shifts associated with each resource. Based on the weight values associated with each candidate shift, the method determines a schedule of shifts, for each resource in rank order.

### CROSS-REFERENCE TO RELATED APPLICATIONS

This application is a continuation-in-part application of U.S. application Ser. No. 10/693,623, filed Oct. 23, 2003, which claims the benefit of U.S. Provisional application No. 60/420,920, filed Oct. 23, 2002.

### TECHNICAL FIELD

The present invention is related to determining an at least near optimal schedule for utilizing resources, and, in particular, to a method and system for determining an at least near optimal schedule of resources that increases customer satisfaction and resource satisfaction, and that lowers operational costs.

### BACKGROUND OF THE INVENTION

Managers are often faced with the difficult task of scheduling resources, such as labor and/or equipment, in an effort to increase customer satisfaction and resource satisfaction while, at the same time, lowering operational costs. In general, customer satisfaction is achieved by supplying an appropriate number of resources that satisfy expected customer needs during a given time interval. The number of resources needed to satisfy customer needs during a given time interval is referred to as “demand.” For example, during the checkout phase of a typical retail store transaction, customer satisfaction may be achieved by staffing an appropriate number of qualified cashiers to lessen customer-checkout-wait-time and address customer needs. However, there is a need to balance customer satisfaction with operating costs. For example, payroll costs typically contribute significantly to the operating costs of a retail store. Staffing a large number of cashiers may significantly increase customer satisfaction, but at the expense of reducing profits. Moreover, managers need to ensure that resource satisfaction is also achieved. For example, a manager may wish to retain valued employees because of their experience, expertise, and loyalty to the organization over a long period of time. Typically, managers may take into consideration seniority, job, and shift preferences, scheduling paid and unpaid breaks, consecutive days off, decreasing boredom and frustration by assigning the right mixture of work activities, and assigning overtime, when appropriate, in an effort to achieve employee satisfaction. Equipment satisfaction may be achieved by taking into consideration deterioration, depreciation, and maintenance.

In general, managers use a fixed schedule of shifts to assign resources. FIGS. 1-4 illustrate an example of assigning cashiers to fixed shifts in order to satisfy customer checkout demand on a typical shopping day at a hypothetical retail store. In FIGS. 1-4, horizontal axes, such as axis 101 in FIG. 1, corresponds to the time, in hours, the retail store is open on a typical shopping day. FIG. 1 is a plot of a hypothetical demand curve for cashier services during operating hours of the hypothetical retail store. In FIG. 1, vertical axis 102 corresponds to the demand for cashiers. Demand curve 105 represents the demand for cashier services between opening time 103 and closing time 104. For example, between 12 pm 106 and 3 pm 107, the demand for cashier services is 4 cashiers, as indicated by edge 108 of curve 105. Between opening time 103 and 5 pm 109, the demand for cashier services steadily increases followed by a rapid decrease in demand between 6 pm 110 and closing time 104.

In general, employers and managers divide the workday into fixed overlapping shifts in an effort to simplify the task of scheduling employees. FIG. 2 illustrates three of many possible fixed overlapping shifts employed to satisfy the demand curve shown in FIG. 1. In FIG. 2, three 9-hour shifts, referred to as “morning,” “afternoon,” and “evening,” are represented by lines 201-203, respectively. For example, line 201 represents a 9-hour morning shift beginning at 8 am 204 and ending at 5 pm 205. The shifts are staggered in time by 2 hours so that the maximum number of cashiers present during the day coincides as close as possible to periods of highest customer demand.

A retail store manager having only 5 cashiers available to work on a given day may use the fixed shifts described in FIG. 2 to assign 2 cashiers to the morning shift 201, 2 cashiers to the mid-day shift 202, and 1 cashier to the evening shift 203. FIG. 3 is a plot of the number of cashiers scheduled during open hours of the hypothetical retail store described above with reference to FIGS. 1 and 2. In FIG. 3, vertical axis 301 corresponds to the number of working cashiers. Curve 302 represents the number of cashiers working per hour in an effort to satisfy customer demand represented by demand curve 105 (FIG. 1) and is one example of a “supply curve.” Supply curve 302 is constructed by summing the number of employees assigned to work per hour. For example, edge 303 of supply curve 302 indicates that 5 cashiers are assigned to satisfy customer demand between the times 12 pm 304 and 5 pm 305 and is determined by summing the number of employees assigned to shifts 201-203 between times 12 pm 206 and 5 pm 205 in FIG. 2.

Subtracting supply curve 303 from demand curve 105 (FIG. 1) identifies the time periods of possible overstaffing and understaffing. Overstaffing is the condition of having more resources scheduled than are needed to satisfy expected demand. During an overstaffing period, employees may be idle, which increases business operating costs because employees are receiving pay for not working. Understaffing is the condition of needing more resources to satisfy expected demand than are or can be scheduled, which lowers the level of customer satisfaction by increasing customer wait time. FIG. 4 is a plot identifying overstaffing and understaffing for the demand and supply curves shown in FIGS. 1 and 3, respectively. In FIG. 4, vertical axis 401 corresponds to the demand curve (105 FIG. 1) minus supply curve (302 FIG. 3). Hash-marked region 402 identifies a period of overstaffing, and shaded regions 403 and 404 identify periods of understaffing. The information provided in FIG. 4 can be used by a retail store manager to assign cashiers the additional task of straightening counters or handling customer returns during the overstaffing period identified by region 402. In an effort to satisfy customer demand, the retail store manager may assign other employees assigned to complete tasks elsewhere in the store, such as stocking, to double as cashiers during the understaffing period identified by regions 403 and 404.

The example provided above with reference to FIGS. 1-4 represents a simplified model of customer demand and resource supply for a hypothetical retail store. In real life, employers and managers responsible for scheduling a large number of employees, such 20, 50, 500, 1,000 or more employees, are faced with the difficult task of achieving customer satisfaction and employee satisfaction while, at the same time, lowering operating costs. Employers and managers may also need to consider each employee's skills, experience, seniority, pay-rate, and availability to determine a schedule of employees. Moreover, managers may need to schedule equipment, such as vehicles and tools, used to perform specific tasks. Employers and managers continue to seek better, generally applicable methods and systems for scheduling resources that increase customer satisfaction and resource satisfaction while, at the same time, decreasing operational costs.

### SUMMARY

Various embodiments of the present invention schedule resources in a way that increases customer satisfaction and resource satisfaction and that decreases operating costs. One embodiment of the present invention provides a method for determining an at least near optimal schedule of resources in linear time by providing an optimal resource ordering scheme. The method receives a set of resources and associated resource data. The method determines a resource-rank-function value for each resource, based on the associated resource data. Based on the resource-rank-function value associated with each resource, each resource is rank ordered. For each resource, the method determines a set of candidate shifts, based on the associated resource data. The method determines a weight value for the candidate shifts associated with each resource. Based on the weight values associated with each candidate shift, the method determines a schedule of shifts for each resource in rank order.

### BRIEF DESCRIPTION OF THE DRAWINGS

FIG. 1 is a plot of a hypothetical demand curve for cashier services during operating hours of a hypothetical retail store.

FIG. 2 illustrates three of many possible fixed overlapping shifts employed to satisfy the demand curve shown in FIG. 1.

FIG. 3 is a plot of the number of cashiers scheduled during open hours of a hypothetical retail store.

FIG. 4 is a plot identifying overstaffing and understaffing.

FIG. 5 illustrates eligibility of hypothetical resources for hypothetical workloads.

FIG. 6A shows plots of availabilities for three hypothetical resources.

FIG. 6B is a plot of the total availability of the three hypothetical resources shown in FIG. 6A.

FIGS. 7A-D are plots of hypothetical demand curves.

FIG. 8 is table of assignment costs for resources and workloads shown in FIG. 5.

FIG. 9 is a table of hypothetical workload costs for the workloads shown in FIG. 5.

FIG. 10 is a table of hypothetical minimum average qualifications for the workloads shown in FIG. 5.

FIG. 11 is table of hypothetical qualification levels for the resources and workloads shown in FIG. 5.

FIG. 12 is a table displaying variables and rank values determined for three hypothetical resources.

FIG. 13 is a table of the average qualifications needed for each workload of a hypothetical resource.

FIG. 14 is a table of the qualification costs for each workload of a hypothetical resource.

FIG. 15 is a plot of the total availability of remaining hypothetical resources.

FIGS. 16A-C are plots of raw-demand curves.

FIGS. 17A-C are plots of adjusted-raw-demand curves.

FIGS. 18A-C are plots of weight lists.

FIG. 19 illustrates a set of candidate-shift assignments for a hypothetical resource.

FIGS. 20A-C illustrate determining weight values for a hypothetical candidate shifts based on the weight lists shown in FIGS. 18A-C.

FIG. 21 shows weight values associated with each candidate shift shown in FIG. 19.

FIGS. 22-23 illustrate shift assignments for a hypothetical resource.

FIGS. 24A-B illustrates the concept of a minimum gap between shifts within a single period.

FIG. 25 illustrates shortening the availability time interval for a last shift in a first period in order to increase the length of the availability time interval for a first shift in a second period.

FIGS. 30A-C are plots of demand curves for workloads after assignment of a hypothetical resource.

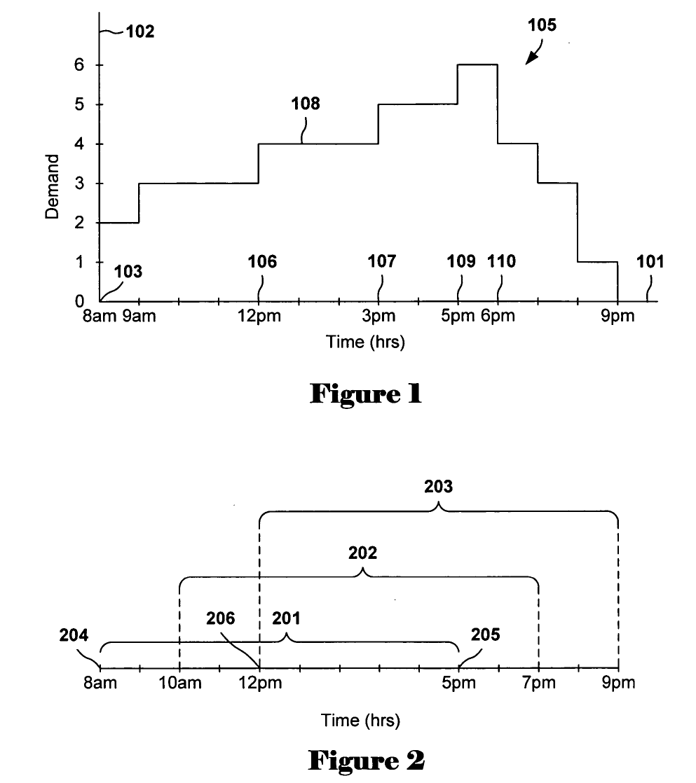

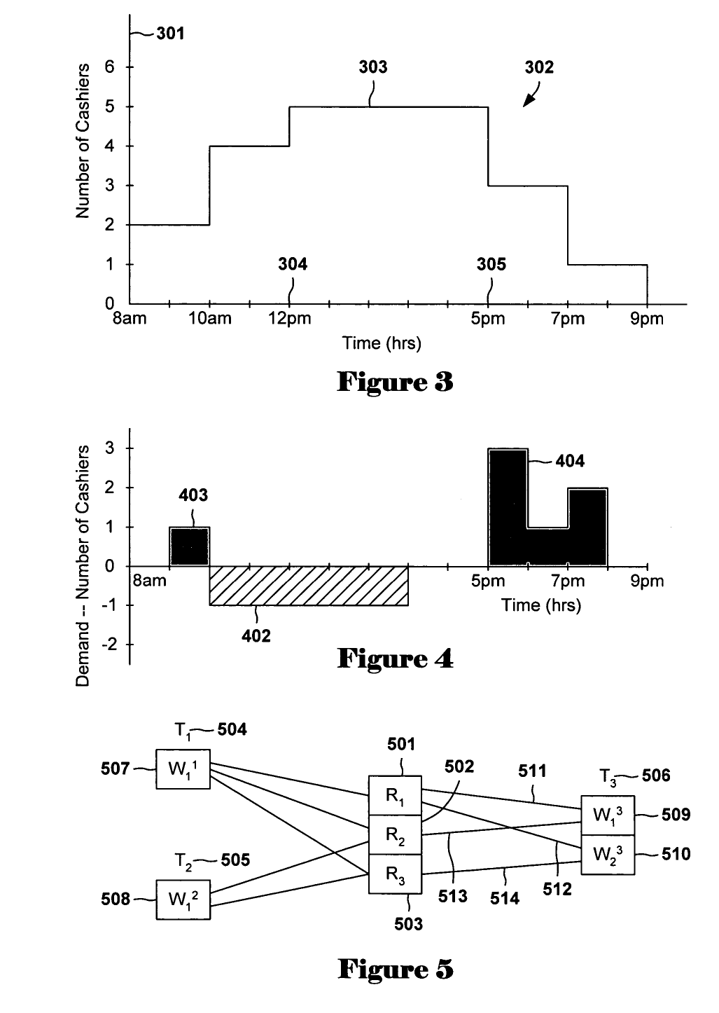

FIG. 27 is a control-flow diagram that represents one of many possible embodiments of the present invention.

FIG. 28 is a control-flow diagram for a routine “Scheduler” that represents one of many possible embodiments of the present invention.

FIG. 29 is a control-flow diagram for a routine “Determine Weight List” that represents one of many possible embodiments of the present invention.

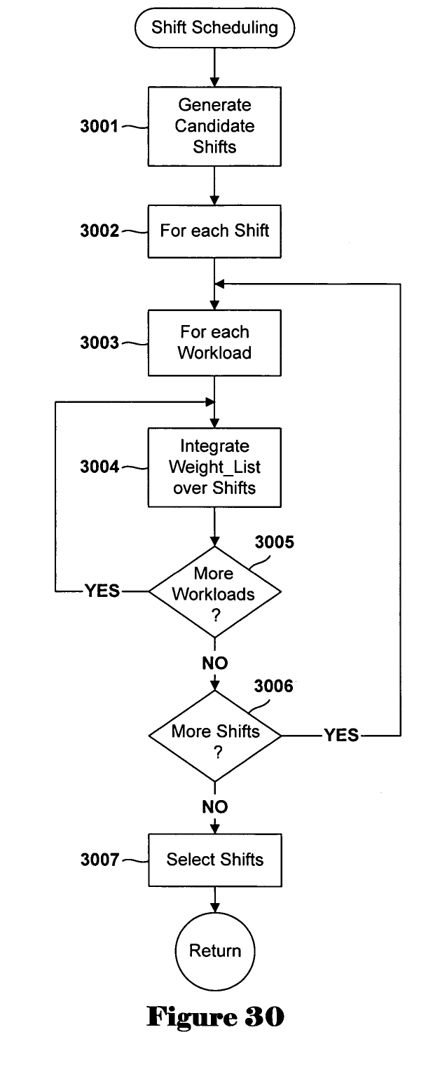

FIG. 30 is a control-flow diagram for a routine “Shift Scheduling” that represents one of many possible embodiments of the present invention.

### DETAILED DESCRIPTION OF THE INVENTION

Embodiments of the present invention are directed to a method for determining an at least near-optimal schedule of available resources that increases customer satisfaction and resource satisfaction and that decreases operational costs. One embodiment of the present invention provides a method for determining an at least near optimal schedule of resources in linear time by providing an optimal resource ordering scheme. The present invention is described, in part below, with reference to a hypothetical set of resources and associated resource data, and with reference to graphical illustrations, control-flow diagrams, and mathematical equations, and includes the following four subsections: (1) Brief Overview; (2) Input; (3) Scheduling Resources; and (4) Implementation.

### Brief Overview

Various embodiments of the present invention are provided with one or more tasks and one or more resources with which to perform the tasks. The resources may include employees and/or equipment and each task may include one or more work activity. An at least near optimal schedule of the resources is accomplished by first setting up a resource ranking objective function and then ranking each resource from lowest value of the objective function to highest value of the objective function. For each resource, beginning with the resource having the lowest objective function value and ending with the resource having the highest objective function value, the method of the present invention determines a resource schedule. Determination of the resource schedule may be based on the demand and importance associated with each activity, the qualifications needed to perform each activity, and the cost and qualifications associated with scheduling each resource. After each resource is scheduled, the demand for each activity the resource is scheduled to perform is adjusted and any workloads completely satisfied are removed from further consideration in scheduling the remaining higher ranked resources.

### Input

Input to methods that represent embodiments of the present invention includes resource data, demand, costs, and qualifications. Resource data refers to resource supply, such as a list of employees or equipment, and includes information about resource eligibility, availability, and priority. Tasks may include one or more pieces or elements of work where each piece of work is related to a specific activity. These one or more activities are referred to as workloads. For example, a call center task, called “technical support,” can be directed to addressing certain questions about a particular product. Two workloads of the task “technical support” may include answering questions in English and answering questions in Spanish. Resource eligibility refers to whether a particular resource is qualified or capable of performing a particular activity or workload of a task.

FIG. 5 illustrates eligibility of a set of hypothetical resources that are capable of performing certain hypothetical workloads. In FIG. 5, three different resources 501-503 are represented by R₁, R₂, and R₃, respectively, and three different tasks 504-506 are represented by T₁, T₂, and T₃, respectively. Tasks T₁ 504 and T₂ 505 are each composed of a single workload represented by W₁¹ 507 and W₁² 508, respectively. Task T₃ 506 is composed of two workloads represented by W₁³ 509 and W₂³ 510. Note that, for each workload, superscripts refer to the associated task index and subscripts are workload indices. In FIG. 5, each resource is connected to three different workloads via lines, such as line 511, that represent resource eligibility. For example, task T₃ 506 may represent the call center “technical support” described above, and resources R₁ 501, R₂ 502, and R₃ 503 may represent employees. The two workloads W₁³ and W₂³ of the task “technical support” include answering questions about the product in English 509, and answering questions about the product in Spanish 510, respectively. Because resource R₁ 501 is fluent in English and Spanish, resource R₁ is eligible to perform workloads W₁³ 509 and W₂³, as indicated by lines 511 and 512, respectively. Because resource R₂ 502 is fluent in English, line 513 indicates that resource R₂ 502 is eligible to perform workload W₁³. Because resource R₃ is fluent in Spanish, line 514 indicates that resource R₃ 503 is eligible to perform workload W₂³.

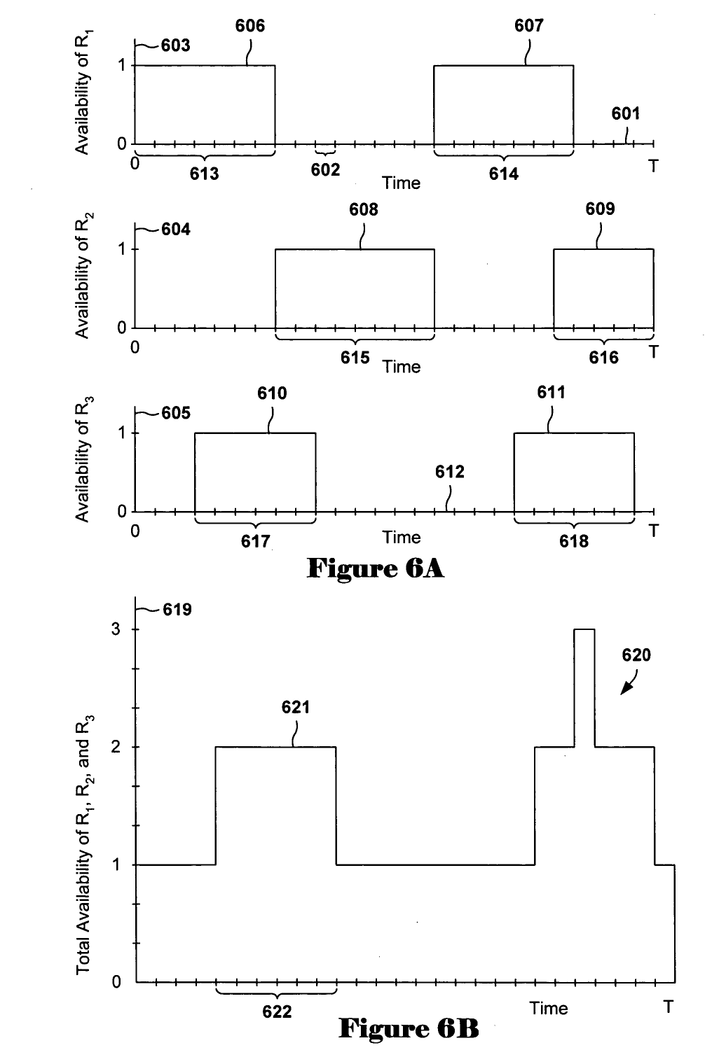

Resource availability refers to time intervals during a scheduling period when a resource is able or willing to work. For example, availability of an employee refers to the time intervals during the week when the employee can and cannot work. FIG. 6A illustrates separate resource availabilities for each of the resources described above with reference to FIG. 5. In FIG. 6A, and in FIG. 6B described below, horizontal axes, such as axis 601, correspond to a time period of length T composed of 26 time units, denoted by t, such as time unit 602. The period is the total number of time units to be scheduled, and each time unit represents the smallest amount of time a resource can be scheduled to work. For example, a time unit may be 0.25 hours (15 minutes), with a scheduled period of one week containing 672 time units (4 units/hour×24 hours/day×7 days/week). In FIG. 6A, vertical axes 603-605 correspond to the resources R₁, R₂, and R₃, respectively. Curves 606-611 are each one unit in height, and identify the availability time intervals 713-718 when resources R₁, R₂, and R₃ can be scheduled to work during the period T. For example, curves 610 and 611 indicate that resource R₃ is available to work during first and second availability time intervals 617 and 618, respectively. Curves 610 and 611 indicate that, during time intervals 617 and 618, resource R₃ is available to execute any of workloads W₁¹, W₁², and W₂³.

FIG. 6B illustrates the total availability of resources R₁, R₂, and R₃ over the period T. In FIG. 6B, vertical axis 619 corresponds to the total availability. Curve 620 represents the total availability of resources R₁, R₂, and R₃ and is produced by summing the availabilities described above with reference to FIG. 6A. For example, edge 621 of curve 620 is the result of summing curves 606, 608, and 610 over the overlapping time units identified by bracket 622. Edge 621 indicates that 2 resources may be available for scheduling during the time units identified by bracket 622.

Resource priority refers the preferential rating of each resource and is assigned by the user. For example, priority may refer to an employee's seniority. Seniority is a privileged status obtained by an employee based on the length of continuous service to an employer. Employees having more seniority than other employees are assigned a higher priority value than employees with less seniority.

Resource data may also include minimum and maximum shift lengths for which the resource can be scheduled. A shift is a contiguous time interval during an availability time interval in which a resource is scheduled to work. In other words, minimum and maximum shift lengths place limits on how long a resource can be scheduled to work during an availability time interval. For example, an employee with a minimum shift length of 4 hours and a maximum shift length of 9 hours can be assigned to any shift during an availability time interval that is not less than 4 hours in length and not more than 9 hours in length.

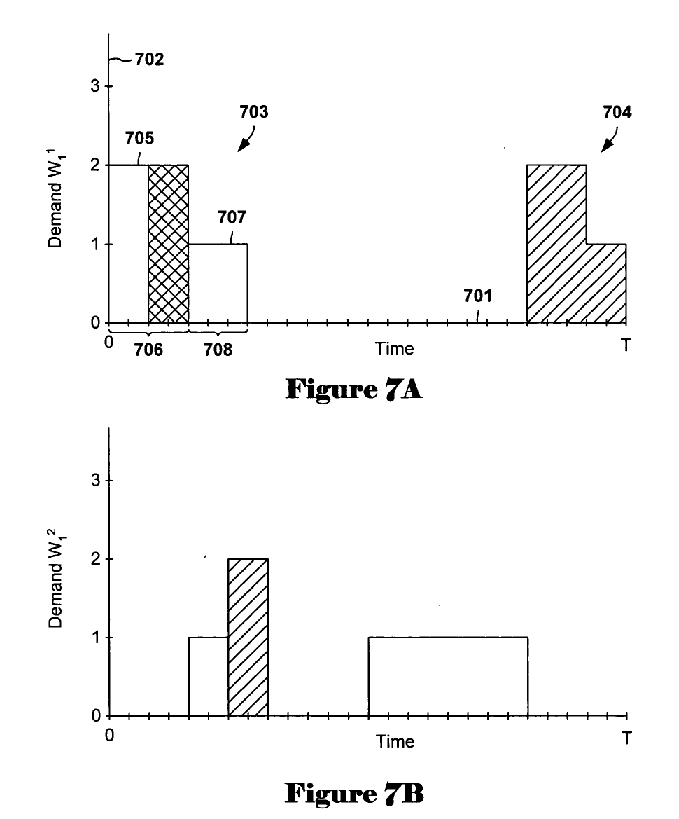

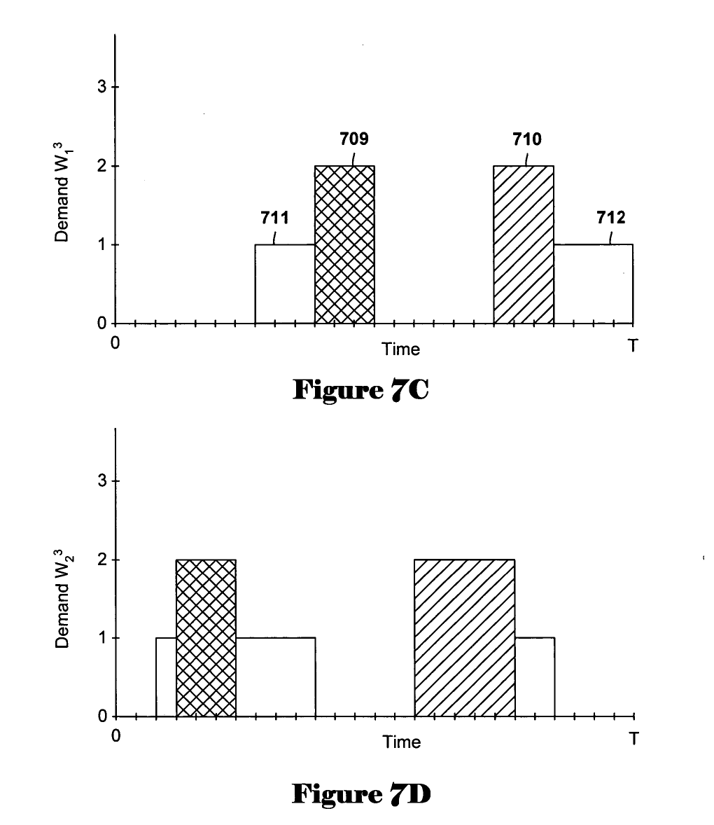

Demand refers to the number of resources needed to satisfy expected customer needs for a given workload during a given interval of time. For example, the demand for a call center can be determined by forecasting the number and kinds of incoming calls received per unit time. Typically, demand is satisfied by assigning an appropriate number of resources to satisfy customer needs. FIGS. 7A-D are plots of hypothetical demand curves for the four workloads W₁¹, W₁², W₁³, and W₂³ described above with reference to FIG. 5. In FIGS. 7A-D, horizontal axes, such as axis 701, correspond to the period T, and vertical axes, such as axis 702, correspond to the demand for resources. In FIGS. 7A-D, demand is represented by curves that indicate the number of resources needed at a given time unit t and is denoted by demand(t). For example, in FIG. 7A, demand for workload W₁¹ (507 in FIG. 5) over the period T is represented by curves 703 and 704. Edge 705 indicates that 2 resources are needed to satisfy customer needs over the time interval 706, and edge 707 indicates that 1 resource is needed to satisfy customer needs over the time interval 708.

The demand curves shown in FIG. 7A-D also include an indication of the importance of satisfying demand. Importance is time-unit dependent and is determined by assigning a value to meeting demand over specific time intervals because satisfying customer demand may be more important in the operation of a business at certain times. Importance determination is outside the scope of the method of the present invention. FIGS. 7A-D identify three different levels of importance. Cross-hatched regions, such as region 709 in FIG. 7C, identify the highest level of importance, hash-marked regions, such as region 710 in FIG. 7C, identify a medium level of importance, and unshaded regions, such as regions 711 and 712 in FIG. 7C, identify a lowest level of importance.

Costs and qualifications includes components of the expenses that the method of the present invention attempts to decrease, such as assignment cost and workload cost. Assignment costs are the cost of scheduling a resource to a particular workload. In other words, for each workload that a resource can perform, there is an associated assignment cost. For example, for an employee resource, the employee's pay rate is a component of assignment costs. For an equipment resource that operates on gasoline, the price per gallon may be a component of assignment costs. Moreover, assignment costs associated with labor can include health care costs and an employee's reluctance to work a particular workload.

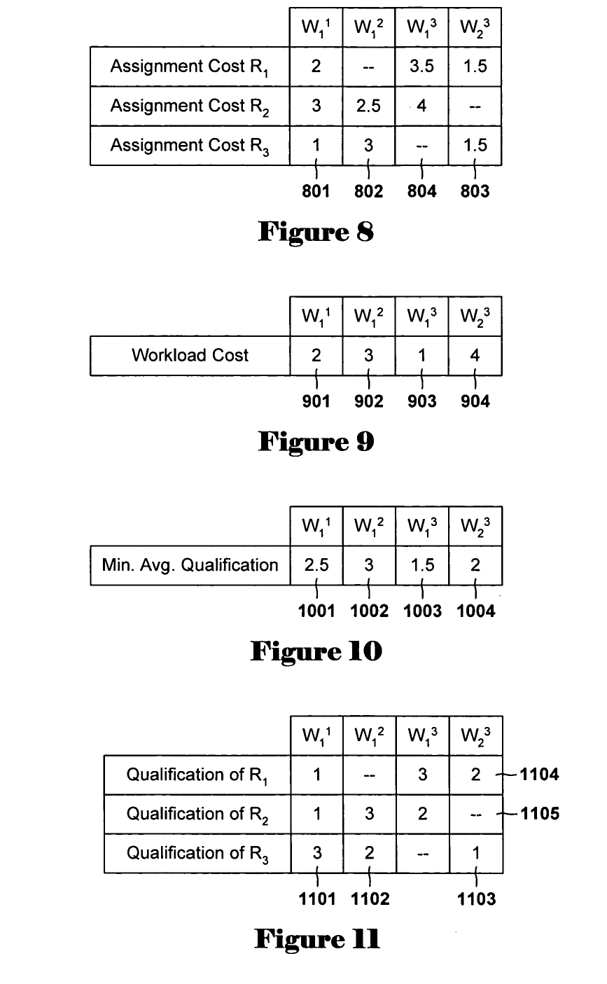

Next, FIG. 8-11 show tables of assignment costs, workload costs, minimum average qualification, and the qualification associated with each workload described above with reference to FIG. 5. Note that the entry values shown in each table represent hypothetical costs and values assigned to workload qualifications. These values are included to aid in illustrating the methods of the present invention, described in greater detail below, and are not intended to represent actual values determined in the practice of the present invention. Note that determining the entry values shown in FIGS. 8-11 is outside the scope of the present invention.

FIG. 8 is a table of assignment costs for the hypothetical resources described above with reference to FIG. 6. In FIG. 8, various entries identify the cost of assigning resource R₁, R_{2, and R}₃ (501-503 in FIG. 5) to their respective eligible workloads W₁¹, W₁², W₁³, and W₂³ (507-510 in FIG. 5). For example, entries 801-803 indicate that the assignment costs of scheduling resource R₃ to workload W₁¹ is 1, the cost of assigning resource R₃ to workload W₁² is 3, and the cost of assigning R₃ to workload W₂³ is 1.5, respectively. Entries with no value, such as entry 804, indicate that workloads a resource is not eligible to perform.

Workload costs represent the costs associated with failing to satisfy demand for a particular workload. For example, consider a retail store that has a task called “sales.” The task “sales” has two workloads: “woman's shoes” and “men's accessories.” Sales people can work one or both of these workloads depending upon their eligibility. Sales in the shoe department are $1,000 per hour per sales person, while sales in the men's department are $300 per hour per sales person. The workload cost assigned to the “women's shoes” is higher because “women's shoes” is the more valuable workload. FIG. 9 is a table of hypothetical workload costs for the workloads shown in FIG. 5. In FIG. 9, entries 901-904 identify hypothetical workload costs for workloads W₁¹, W₁², W₁³, and W₂³, respectively.

Cost and qualifications also includes the minimum average qualification level needed for each workload. The minimum average qualification represents the average level of ability to be maintained in each workload at all times. For example, the task “cashier” in a retail store may include a low qualification workload “checking” and a higher qualification workload “returns.” A lower minimum average qualification value is therefore assigned to the workload “checking” than to the workload “returns.” FIG. 10 is a table of hypothetical minimum average qualifications to be maintained for each workload shown in FIG. 5. In FIG. 10, entries 1001-1004 identify the minimum average qualifications needed to perform workloads W₁¹, W₁^{2, W}₁³, and W₂³, respectively.

Lastly, cost and qualifications includes qualification values associated with each resource. The qualification value represents a resource's ability to perform a particular workload. The qualification value is determined by evaluating each resource's qualifications for performing eligible workloads. For example, a typical retail-store staff may be composed of mixed levels of expertise for each workload. A new cashier may never have handled the workload “returns,” and, as a result, is assigned a low qualification value for the workload “returns,” while another cashier may have handled “returns” for years, and, as a result, is assigned a high qualification value for the workload “returns.” FIG. 11 is a table of the hypothetical qualification levels for each resource per workload. In FIGS. 11, entries 1101-1103 indicate that resource R₃ has a qualification value 3 for workload W₁¹, a qualification value of 2 for workload W₁², and a qualification value of 1 for workload W₂³, respectively.

### Scheduling Resources

First, in one of many possible embodiments of the present invention, each resource is assigned a resource-rank-function value according to the following equation:

$$resource\_rank \_function = [ P + ( \frac{NT}{TNT} ) + ( \frac{MRAC}{MORAC} ) + ( \frac{MOQ - AQ}{MOQ} ) + Tot ]$$

where P=priority;
NT=number of tasks a resource can carry out;
TNT=total number of tasks available;
MRAC=maximum resource assignment costs;
MORAC=maximum overall resource assignment costs;
MOQ=maximum overall qualification of the resources;
AQ=average qualification of a resource; and
Tot=total time the resource is already scheduled for.
   The resource_rank_function represents one of many possible embodiments for ranking each resource. The values given by the resource_rank_function are used to rank the available resources in order from the resource having a lowest resource-rank-function value to a resource having a highest resource-rank-function value. The resources are scheduled in rank order beginning with the lowest ranked resource and ending with the highest ranked resource.

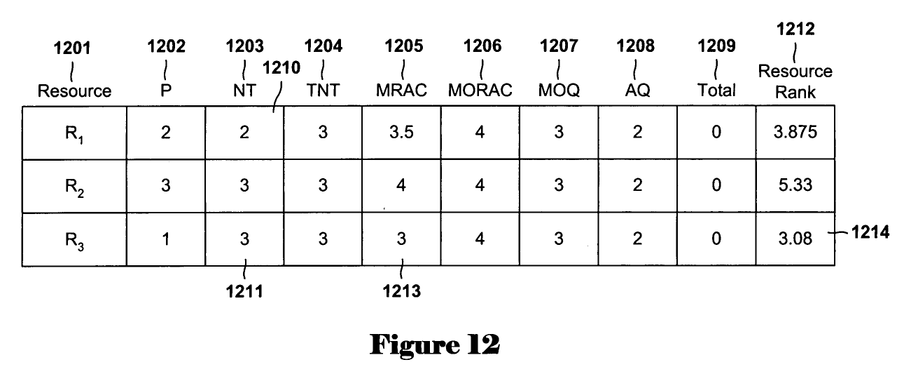

FIG. 12 is a table displaying the input variables and the resource_rank_function determined for hypothetical resources R₁, R_{2, and R}₃ described in FIG. 5. In column 1201, each resource is listed. In column 1202, the priority assigned to each resource is given. In column 1203, the number of tasks each resource is able to perform is given. For example, NT is assigned the value 2 for resource R₁ because resource R₁ is able to perform workloads in the tasks T₁ and T₃ (see in FIG. 5). On the other hand, NT is assigned the value 3 for resources R₂ and R₃ because both resources R₂ and R₃ are eligible to perform workloads in all three tasks T₁, T₂, and T₃ (see FIG. 5). In column 1204, TNT is assigned the value 3 for each resource because the total number of tasks is 3 (see FIG. 5). Column 1205 includes values assigned to the variable MRAC. For example, MRAC 1213 is assigned the value 3 for resource R₃ (see entry 802 in FIG. 8). In column 1206, for each resource, MORAC is assigned the value 4 because 4 is the largest assignment cost value (see entry 804 in FIG. 8). In column 1207, MOQ is assigned the value 3 for each resource (see entry 1002 in FIG. 10). In column 1208, AQ is given for each resource. For example, for resource R₃, AQ is determined by averaging the values located in entries 1101, 1102, and 1103 in FIG. 11. In column 1209, the entries all have the value “0” because the resources have not yet been assigned. In column 1210, the rank of each resource is given, determined by substituting the respective values of each resource into the resource_rank_function.

In order to lower operational cost, the resources are scheduled in order of increasing resource_rank_function, beginning with the resource having the lowest resource_rank_function value. For example, resource R₃ is scheduled first because resource R₃ is the lowest-ranked resource (see entry 1214 of FIG. 12).

Next, for each workload a resource is eligible to perform, the qualification cost is determined. The qualification cost is the cost associated with assigning a particular resource to a particular workload. In one of many possible embodiments of the present invention, the qualification cost for each workload is determined according to the following equation:
qualification_cost (Rᵢ,Wⱼ^{k})=min_ave_qualification (Rᵢ,Wⱼ^{k})−ave_qualification (Rᵢ,Wⱼ^{k})
where i=the resource index;
k=the task index;
j=the workload index;
min_ave_qualification=minimum average qualification of each resource having resource_rank_function values higher than Rᵢ, and
ave_qualification=average qualification of each resources having resource_rank_function values higher than Rᵢ.
   The qualification_cost is first determined for the lowest-ranked resource according the resource_rank_function described above with reference to FIG. 12. For example, because resource R₃ has the lowest resource_rank_function value, the qualification_cost is determined for each workload that resource R₃ is eligible to perform. Determination of the qualification_cost is based on the unscheduled resources. For example, the qualification_cost for the lowest-ranked resource R₃ is based on the qualification values described above with reference to FIGS. 10 and 11.

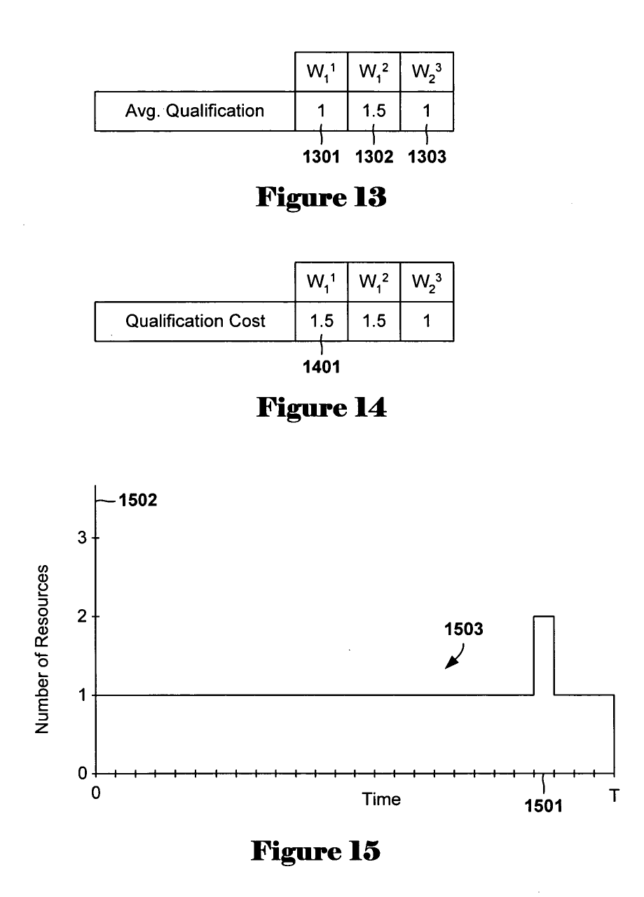

FIGS. 13 and 14 are tables illustrating determination of the qualification_cost for resource R₃. FIG. 13 is a table of ave_qualification of unscheduled resources R_and R₂. The ave_qualification is determined for resources having a resource_rank_function value higher than resource R₃. In FIG. 13, entries 1301-1303 are the average qualification values for the resources R₁ and R₂. For example, ave_qualification(R₃, W₂³) entry 1303 is determined by averaging qualification values for resources R₁ and R₂ and for the workload W₂³ ((2+0)/2; see entries 1104 and 1105 in FIG. 11). FIG. 14 is a table of qualification_cost values determined by subtracting entries 1301-1303 from entries 1001, 1002, and 1004 in FIG. 10, respectively.

Although, embodiments of the present invention are directed to scheduling a lower ranked resource before a higher ranked resource, typically higher ranked resources have higher priority with respect to workloads. In order to accommodate the higher ranked resources, the workload demand curves associated with the lower ranked resources are adjusted by subtracting the availability of the unscheduled higher ranked resources. In other words, the lower ranked resources are scheduled based on the assumption that higher ranked resources have already been scheduled. For example, the availability of unscheduled resources R₁ and R₂ is subtracted from the workload demand curves associated with the lowest ranked resource R₃ in order to determine the demand for resource R₃. FIG. 15 is a plot of the availability of remaining unscheduled resources R₁ and R₂. In FIG. 15, horizontal axis 1501 corresponds to the period T, and vertical axis 1502 corresponds to the number of available resources. Curve 1503 represents the availability of unscheduled resources R₁ and R₂ after scheduling resource R₃ and is referred to as the remaining_availability. Availability curve 1503 is determined by summing availability curves 606-609 for the resources R₁ and R₂ in FIG. 6A over the period T. Note that availability curve 1503 can also be determined by subtracting availability curves 610 and 611 from availability curve 620 shown in FIG. 6B.

Next, the raw demand for each workload the lowest-ranked resource is eligible to perform is determined. In one of many possible embodiments of the present invention, the raw demand is determined according to the following equation:
raw_demand(t)=demand(t)−remaining_availability(t)
where t=time unit.

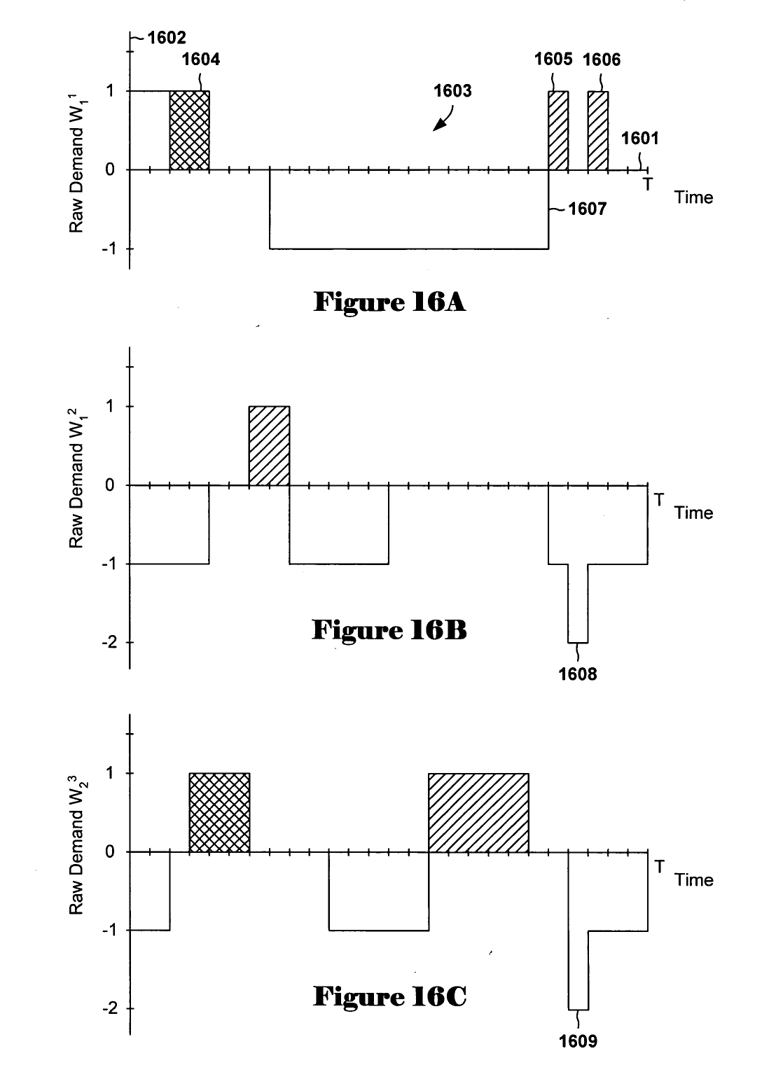

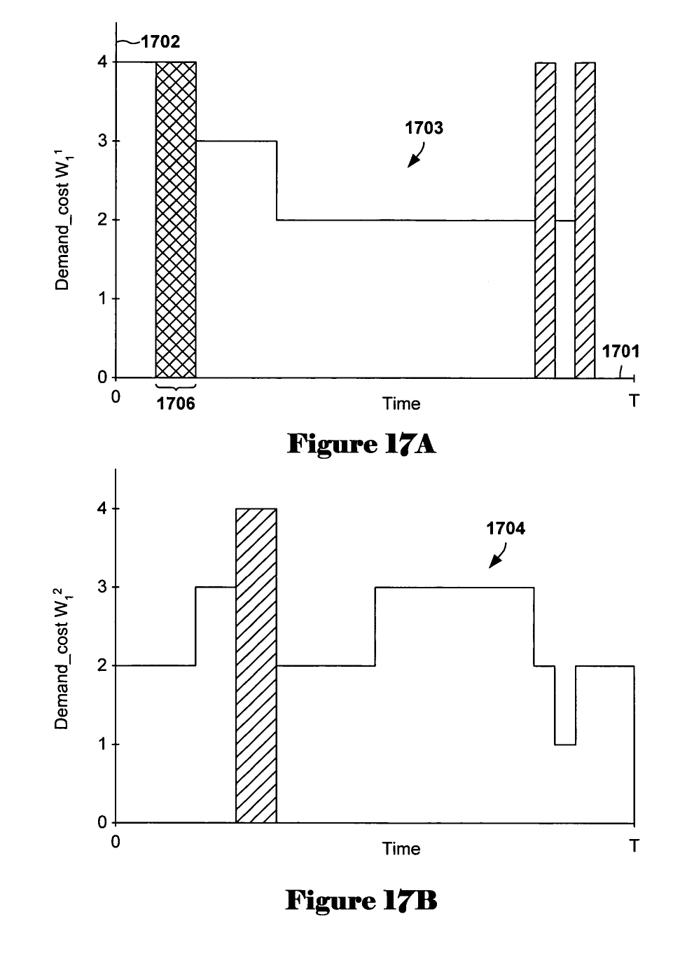

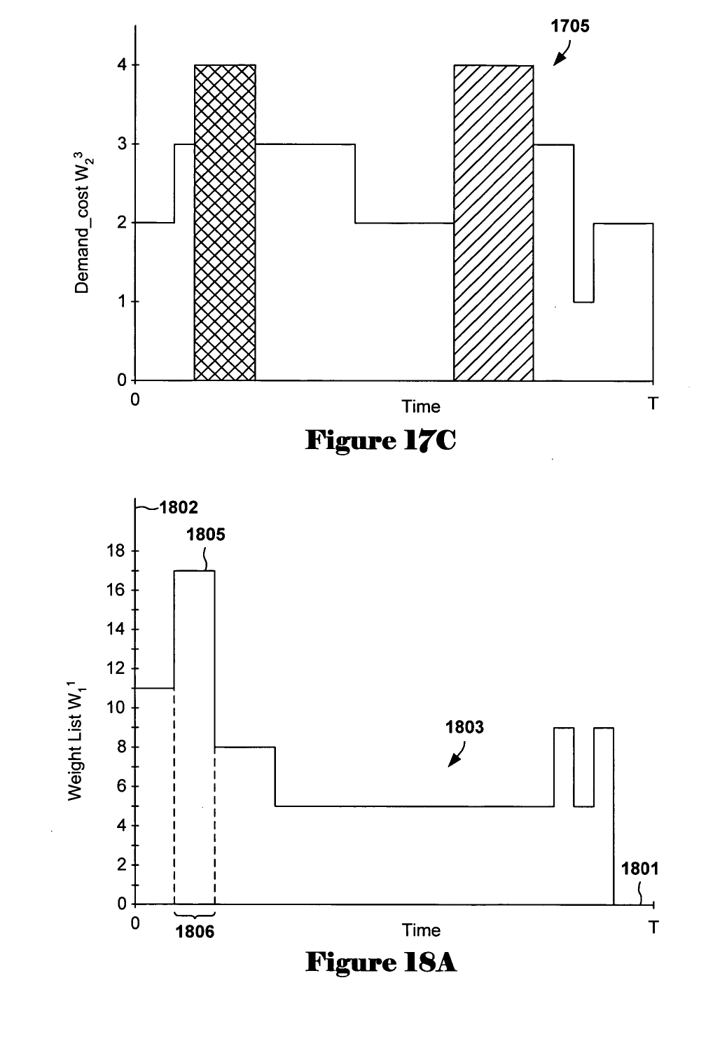

FIGS. 16A-C are plots of raw_demand curves for the lowest-ranked resource R₃. In FIGS. 16A-C, horizontal axes, such as horizontal axis 1601, correspond to the period T, and vertical axes, such as vertical axis 1602, correspond to the raw demand for workloads W₁¹, W₁², and W₂³. The raw-demand curve 1603 in FIG. 16A represents the raw demand for workload W₁¹ which is determined by subtracting the remaining_availability, described above with reference to FIG. 15, from demand(t) curve for workload W₁¹, shown in FIG. 7A. In FIGS. 17A-C, positive-valued regions, such as regions 1604-1606 of workload W₁¹, identify the unsatisfied demand resulting from scheduling resources R₁ and R₂ to the workloads, such as workload W₁¹. In other words, the positive-valued regions identify the demand for the lowest-ranked resource R₃. Negative-valued regions, such as region 1607, identify overstaffing that can result from scheduling resources R₁ and R₂ to identical workloads.

Next, in one of many possible embodiments of the present invention, for each workload the lowest-ranked resource is eligible to perform, the associated raw_demand is adjusted according to the following equation to give:
dem_cost(t)=raw_demand(t)+|overall_minimum|+1.0

where |overall_minimum|=the absolute value of the overall minimum of the raw demand for all workloads the resource is able to perform.

FIGS. 17A-C are plots of the demand_cost for each workload the resource R₃ is eligible to perform. In FIGS. 17A-C, horizontal axes, such as horizontal axis 1701, correspond to the period T, and vertical axes, such as vertical axis 1702, is the demand cost axis. The dem_cost(t) curves 1703-1705 represent the dem_cost(t), for each workload the resource R₃ is eligible to perform. For example, the overall_minimum of the raw demand for resource R₃ is “−2,” as indicated by edges 1608 and 1609 in FIGS. 16B-C. According to dem_cost(t) equation, curve 1703 is determined by adding the absolute value of the overall-minimum value “2” plus the value “1” to the raw_demand(t) shown in FIG. 17A.

Next, in one of many possible embodiments of the present invention, the weight list for each workload the lowest-ranked resource is eligible to perform is computed according to the following equation:
weight_list(t)=workload_cost×qualification_cost×importance(t)×dem_cost(t)−assignment_cost

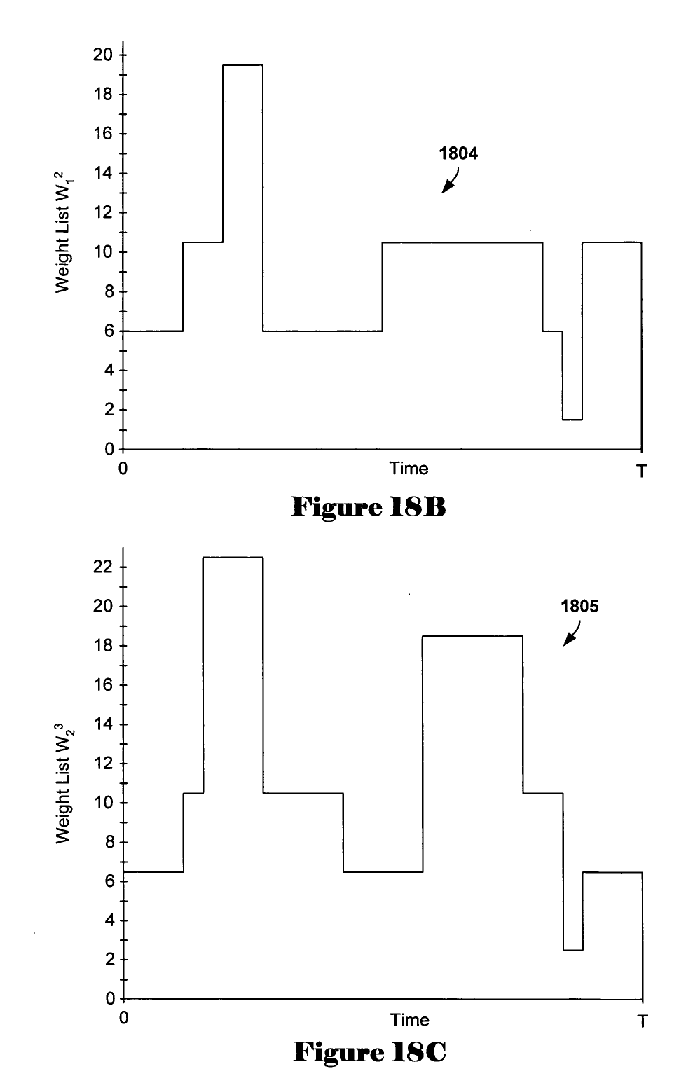

FIGS. 18A-C are plots of the weight list determined for the workloads W₁¹, W₁², and W₂³ the resource R₃ is able to perform. In FIGS. 18A-C, horizontal axes, such as axis 1801, correspond to the period T, and vertical axes, such as vertical axis 1802, correspond to the weight list values. Weight list curves 1803-1805 are determined according to the equation weight_list for each workload resource R₃ is eligible to perform For example, in FIG. 18A, the weight_list value is “17” over the time interval 1806 and is computed by substituting the value “2” for the workload_cost (entry 901 in FIG. 9); the value “1.5” for the qualification_cost (entry 1401 in FIG. 14); the value “1.5” for the importance, as described above with reference to FIG. 7A; the value “4” for the dem_cost (time interval 1706 in FIG. 17A); and the value “1” for the assignment_cost (801 in FIG. 8) into the equation weight_list(t).

Next, all possible candidate shifts are generated for the lowest-ranked resource based on the minimum and maximum shift length provided in the resource data described above. Resources are scheduled so that the length of each shift is between the minimum and maximum specified shift lengths. Beginning with the minimum shift and ending with the maximum shift, candidate shifts are generated by incrementally enlarging the length of each shift by the time unit t. For example, an employee that specifies a minimum shift length of 7 hours and a maximum shift length of 9 hours can be scheduled to shifts of lengths 7, 7.25, 7.5, 7.75, 8, 8.25, 8.5, 8.75, and 9 hours, where the time unit t is 0.25 hours. For the sake of simplicity, the resource R₃ has a minimum shift length of 2 time units and a maximum shift length of 5 time units, the possible shifts lengths, in time units, are 2, 3, 4, and 5 time units.

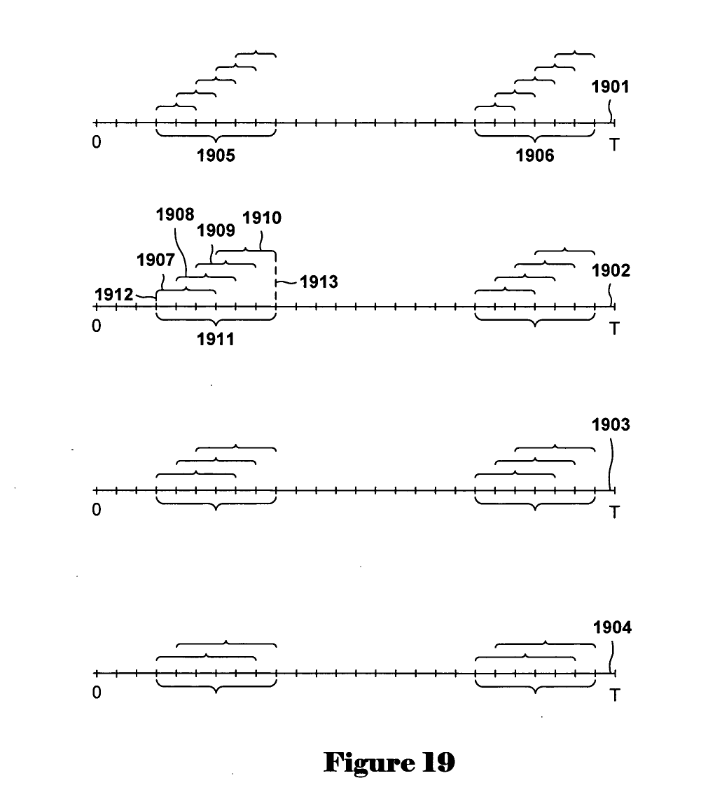

After the possible shift lengths have been determined, all possible candidate shift assignments are determined for each availability time interval of the resource. FIG. 19 illustrates the set of all possible candidate shift assignments for the resource R₃. In FIG. 19, the four horizontal axes 1901-1904 correspond to the period T, and square bracketed time units, such as time units 1905 and 1906, identify the first and second availability time intervals 610 and 611, shown in FIG. 6A, that are associated with resource R₃. In FIG. 19, each horizontal axis is associated with all possible shifts of the same time unit length, and the shifts are staggered by one time unit in order to span each availability time interval. For example, the candidate shifts associated with period 1902 are all 3 time units long, and candidate shifts 1907-1910 represent all shifts of 3 time units that can be scheduled during the availability time interval 1911, as indicated by dashed lines 1912 and 1913.

Next, in one embodiment, the weight function value for each candidate shift is determined by integrating each weight list over the time interval associated with each candidate shift according to the following equation:

$$weigh t ( s ) = {{\int }_{shift\_s \_start}}^{shift\_s \_end} weight\_list ( t ) ⅆ t$$

where shift_s_start and shift_s_end are the starting and ending shift times.

A near optimal schedule for a resource is determined by selecting shifts or combinations of shifts based on their associated weight value, weight(s).

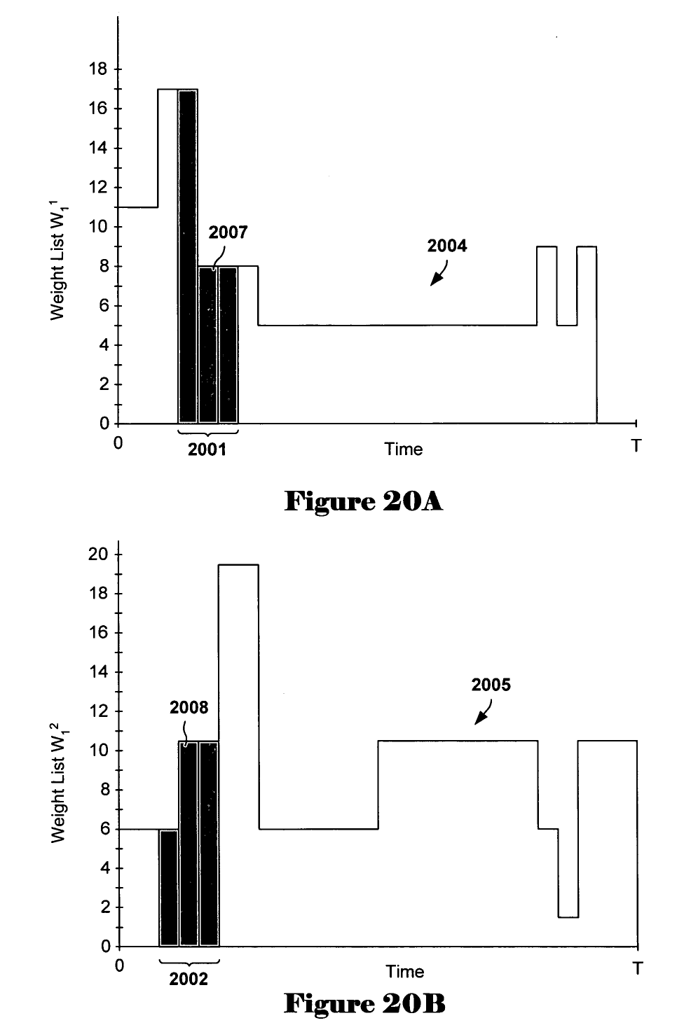

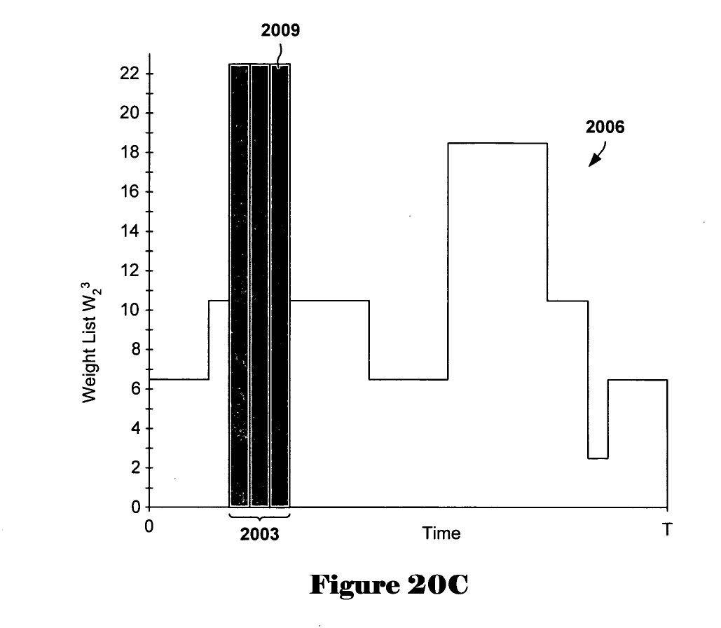

Based on the weight lists shown in FIGS. 19A-C, FIGS. 20A-C illustrate determination of weights for candidate shift 1907, shown in FIG. 19. Curves 2004-2006 coincide with curves 1803-1805, shown in FIG. 18. In FIGS. 20A-C, time intervals 2001-2003 identify time units corresponding to candidate shift 1907. For the sake of simplicity in determining the weight(s) values, the time units are each assigned the value “1.” For example, for each workload W₁¹, W₁², and W₂³, the weight(s) values associated with candidate shift 1907 are the areas identified by shaded regions 2007-2009, respectively. The area of shaded regions 2007-2009 are 33, 29, and 67.5, respectively.

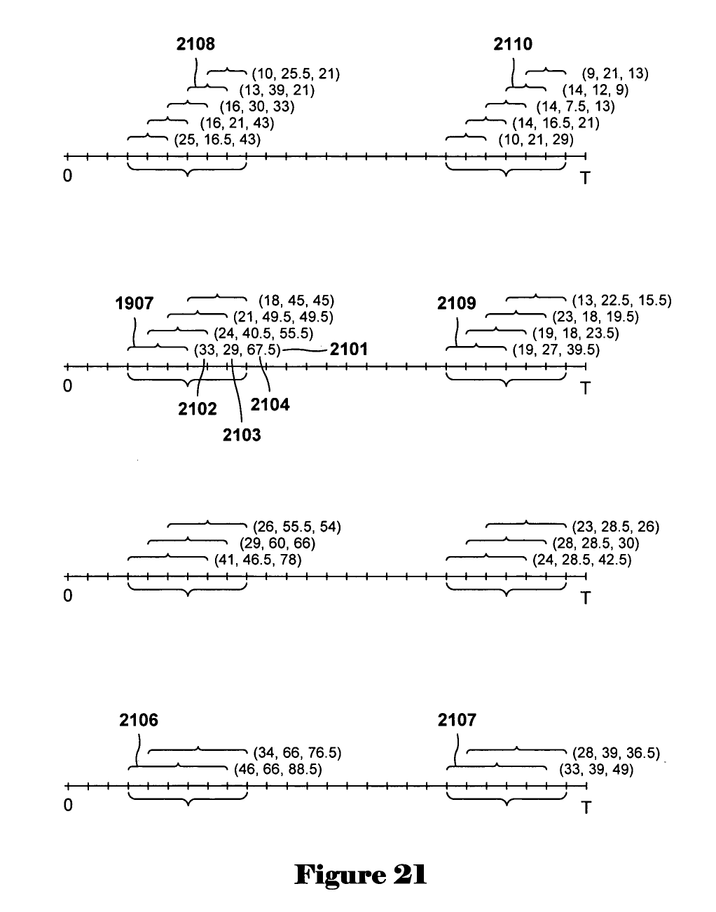

FIG. 21 shows the weight values computed for each candidate shift shown in FIG. 19. In FIG. 21, order 3-tuples, located to the right of each candidate shift, such as 3-tuple 2101, give the computed weight(s) values for the candidate shifts associated with each weight_list shown in FIGS. 18A-C, and are determined as described above with reference to FIGS. 20A-C. For example, the elements of 3-tuple 2101, associated with shift 1907, are “33,” “29,” and “67.5,” as described above with reference to FIGS. 20A-C.

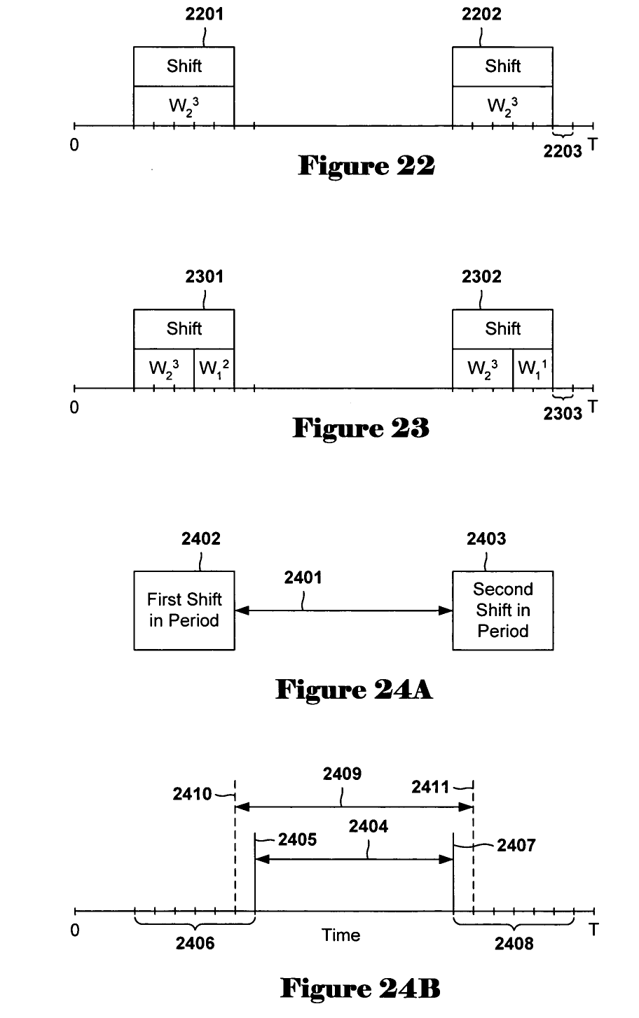

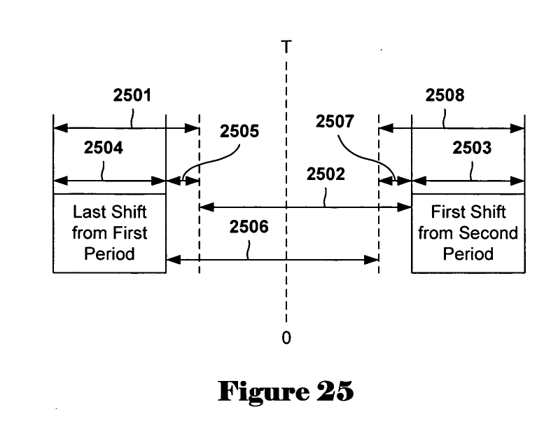

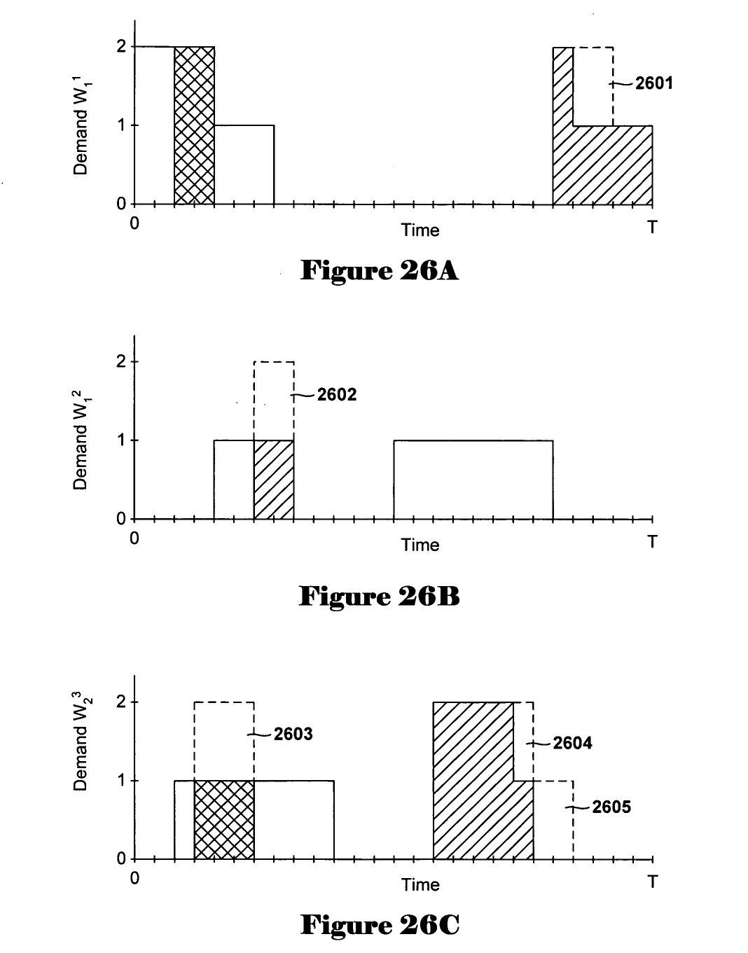

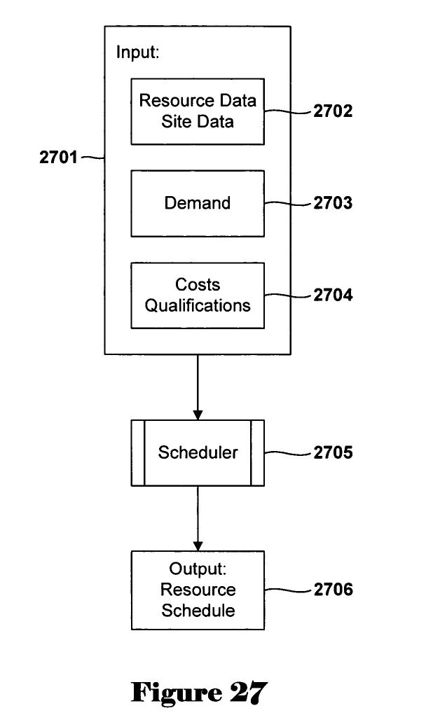

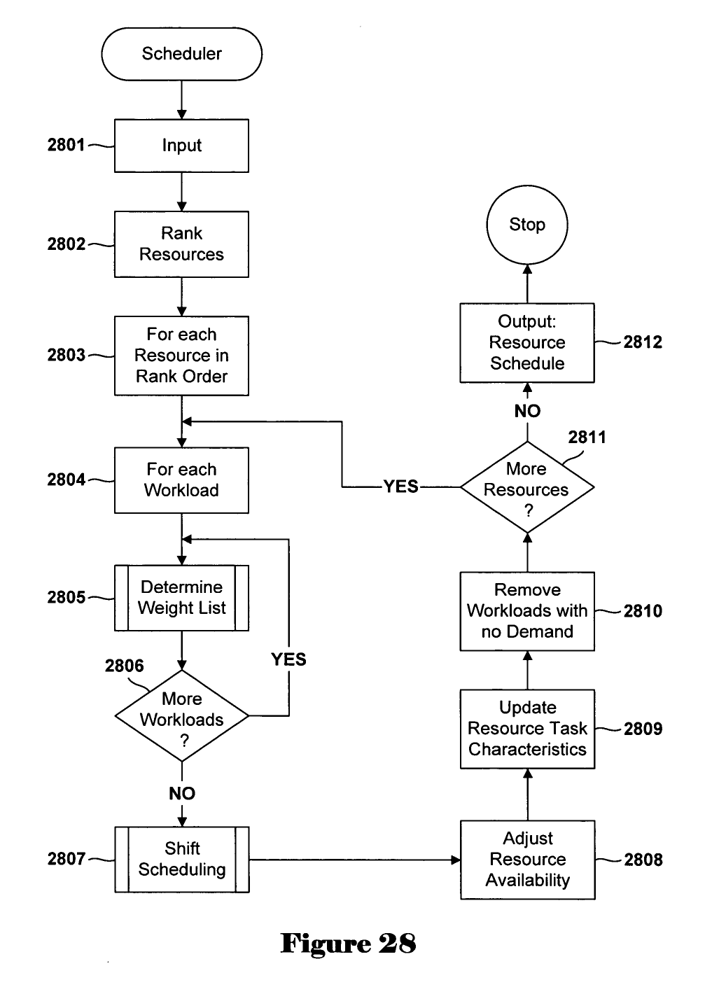

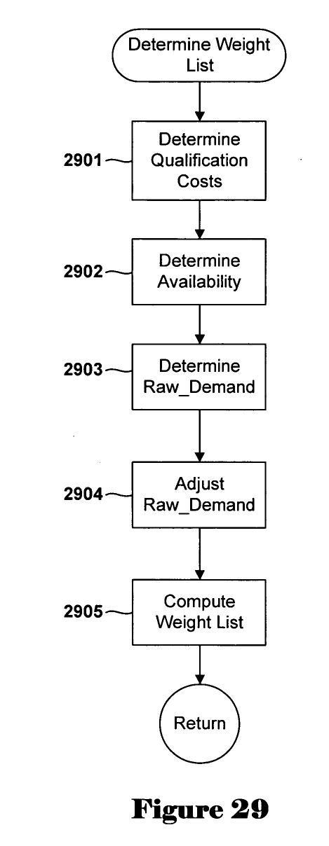

After all weight(s) values have been determined for each candidate shift, candidate shifts having the largest weight(s) values are used to determine the lowest-ranked resource's schedule. FIGS. 22-23 illustrate possible shifts assignments for resource R₃ based on the weight(s) values shown in FIG. 21. The schedule for resource R₃ can be determined by selecting those shifts having the largest weight(s) values. For example, examination of weight(s) values for each candidate shift in FIG. 21 reveals that shifts 2106 and 2107 have the largest weight(s) values “88.5” and “49,” respectively, for the workload W₂³. In FIG. 22, resource R₃ can be scheduled to perform workload W₂³, as indicated by shifts 2201 and 2202. In an alternate embodiment, combinations of shifts can be used to determine a near optimal schedule for resource provided the candidate shift lengths do not exceed the maximum shift length constraint. For example, in FIG. 23, shifts 1907 and 2108, shown in FIG. 25, can be combined to give a first shift 2301 having total weight(s) value “108.5 (67.5+39),” and a shifts 2109 and 2110, shown in FIG. 25, can be combined to give a second shift 2302 having total weight(s) value “53.5 (39.5+14).”

In alternate embodiments, each shift may also be subject to a minimum gap between shifts constraint. The minimum gap between shifts is the amount of continuous time off between shifts. For example, a minimum gap between shifts constraint of 16 hours allows an employee to go home eat, sleep and return to work. The minimum gap between shifts constraint is a parameter that achieves resource satisfaction. FIGS. 24A-B illustrate the concept of a minimum gap between shifts within a single period. In FIG. 24A, the minimum gap 2401 between shifts is located between the end of a first shift 2402 and the beginning of a second shift 2403. The minimum gap 2401 between shifts 2401 constraint ensures that the end of the first shift 2402 is not to too close in time to the beginning of the second shift 2403. If the distance between the end of the first availability time interval and the beginning of the second availability time interval is less than the minimum gap between shifts, then the availability time intervals are adjusted by shortening the length of either one or both of the availability time intervals. For example, in FIG. 24B, the distance 2404 between the end 2405 of the first availability time interval 2406 and the beginning 2407 of the second availability time interval 2408 is less than the minimum gap between shifts 2409. The length of the first and second availability time intervals 2406 and 2408 can both be shortened by one time unit to accommodate the minimum gap 2409 by shifting end 2405 of availability time interval 2406 to end 2410 and shifting beginning 2407 of availability time interval 2408 to the beginning 2411.

FIG. 25 illustrates the concept of shortening the availability time interval for the last shift in the first period in order to increase the length of the availability time interval for the first shift in the second period. In FIG. 25, the length of the last availability time interval 2501 in the first period and the minimum gap 2502 between shifts shortens the length of the first availability time interval 2503 of the second period. However, after the last shift from the first period is assigned to the time interval 2504, gap 2905 is removed from the availability time interval 2501 and minimum gap 2502 shifts to minimum gap 2506. The availability time interval 2503 is expanded by gap 2507 to the time interval 2508. The increased availability time interval length 2508 increases the range of time over which the first shift of the second period can be scheduled.

FIGS. 26A-C are plots of updated demand curves for workloads W₁¹, W₁², and W₂³, after resources R₃ has been assigned to the shifts shown in FIG. 23. The demand curves shown in FIGS. 26A-C are determined by subtracting the shifts assignments shown in FIG. 23 from the corresponding demand curves shown in FIG. 7A, B, and D. Dashed line enclosed regions 2601-2605 identify the demand satisfied by assigning resource R₃ to the workloads show in FIG. 23. The demand curves shown in FIGS. 26A-C are used in subsequent scheduling of the next lowest-ranked resource R₁ (see FIG. 12).

In step 1310, the workloads having demand completely satisfied are removed. For example, none of the demand curves shown in FIGS. 8A-D are removed because scheduling resource R₃ to the shifts shown in FIG. 27 does not completely satisfy the demand for workloads W₁¹, W₁², or W₂³ (see FIGS. 30A-C). In step 1311, if more resources are available for scheduling, such as resources R₁ and R₂, then steps 1304-1311 are repeated, otherwise, control passes to step 1312. In step 1312, the optimal resource schedule is output.

### Implementation

FIGS. 27-30 provide a series of control-flow diagrams that describe the method of determining a near optimal schedule of resources, as described above with reference to FIGS. 5-26. FIG. 27 is a control-flow diagram that represents one of many possible embodiments of the present invention. In step 2701, the input is composed of resource data and site 2702, described above with reference to FIGS. 5 and 6, demand 2703, described above with reference to FIGS. 7A-D, and cost and qualification 2704, described above with reference to FIGS. 8-11. In step 2705, the input described above with reference to step 2701 is passed to the routine “Scheduler.” In a single iteration, the routine “Scheduler” converts the input into an at least near optimal resource schedule. I step 2706, output consist of the at least near optimal schedule.

FIG. 28 is a control-flow diagram for the routine “Scheduler” that represents one of many possible embodiments of the present invention. The routine “Scheduler” determines a near optimal schedule of resources that increases customer satisfaction and resource satisfaction and lowers operating costs. In step 2801, the input described above with reference to step 2701 in FIG. 27 is provided. In step 2802, a resource_rank_function value, described above with reference to FIG. 12, is determined for each resource. In outerfor-loop of step 2803, steps 2804-2811 are repeated for each resource beginning with the resource having the lowest resource_rank_function value and ending with the resource having the highest resource_rank_function value. In innerfor-loop of step 2804, steps 2805-2806 are repeated for each workload a resource can perform. In step 2805, the routine “Determine Weight List” is called. In step 2806, if more workloads are available, then step 2805 is repeated, otherwise, control passes to step 2807. In step 2807, the weight lists determined in steps 2804-2806 are passed to the routine “Shift Scheduling” and a near optimal shift schedule is determined for lowest-ranked resource. In step 2808, resource availability is adjusted as described above with reference to FIGS. 24-25. In step 2809, resource task characteristics such average qualifications (see FIG. 13) is updated, and the demand for each workload is updated, as described above with reference to FIGS. 26A-C. In step 2810, workloads having no demand are removed. In step 2811, if more resource are available for scheduling, then step 2804 is repeated, otherwise control passes to step 2812. In step 2812, a near optimal resource schedule is output.

FIG. 29 is a control-flow diagram of the routine “Determine Weight List” that represents one of many possible embodiments of the present invention. This routine determines a weight list value for each time units over the period T associated with each workload. In step 2901, qualification costs are determined according to the qualification_cost equation, as described above with reference to FIG. 14. In step 2902, availability is determined, as described above with reference to FIG. 15. In step 2903, raw demand is determined according to the raw_demand equation, as described above with reference to FIGS. 16A-C. In step 2904, raw demand is adjusted according to the demand_cost equation, as described above with reference to FIGS. 17A-C. In step 2905, the weight list is determined according to weight_list equation, as described above with reference to FIGS. 18A-C.

FIG. 30 is a control-flow diagram of the routine “Shift Scheduling” that represents one of many possible embodiments of the present invention. This routine determines a near optimal schedule based on the weight list determined in the routine “Determine Weight Lists.” In step 3001, candidate shifts are generated as described above with reference to FIG. 19. In outer for-loop 3002, steps 3003-3006 are repeated for each shift determined in step 3001. In innerfor-loop 3003, steps 3004 and 3005 are repeated for each weight_list determined in the routine “Determine Weight Lists.” In step 3004, the weight_list equation is integrated over the shift time intervals determined in step 3001. In step 3005, if more workloads are available, then step 3004 is repeated, otherwise control passes to step 3006. In step 3006, if more shifts are available, then step 3003 is repeated, otherwise control passes to step 3007. In step 3007, shifts having the largest weight_list value are selected, as described above with reference to FIGS. 22-23.

Although the present invention has been described in terms of a particular embodiment, it is not intended that the invention be limited to this embodiment. Modifications within the spirit of the invention will be apparent to those skilled in the art. For example, an almost limitless number of different implementations of the many possible embodiments of the method of the present invention can be written in any of many different programming languages, embodied in firmware, embodied in hardware circuitry, or embodied in a combination of one or more of the firmware, hardware, or software. In alternate embodiments, capacity can be taken in to account in scheduling resources to ensure that tasks are scheduled within open hours and do not exceed employee maximums. Capacity is the combination of business hours and the maximum number of resources that can perform a task during a particular interval of time. In alternate embodiments, fixed assignments can be accommodated. Fixed assignments are specific shifts for resources. Resources are scheduled to work a fixed shift regardless of demand and can be fixed by task or by resource. In alternated embodiments, where the resources are employees, the present invention can include the scheduling of meetings. If the resources are equipment, the present invention can include scheduling regular periods of maintenance. In alternate embodiments, the minimum and maximum time per period can be implemented to place limits on the amount of time a resource is scheduled during a scheduling period. In alternate embodiments, the maximum number of shifts can be used to limit the number of shifts a resource can work during a scheduling period. In alternate embodiments, where the resources are employees, consecutive time off can be included to ensure an employee receives a minimum amount of continuous time off within a scheduling period. In alternate embodiments, where the resources are employees, paid and unpaid breaks can be scheduled in order to comply with laws and company policy. In alternate embodiments, overtime can be scheduled for employee resources if there is a demand and all possible regular time has been allocated. In alternate embodiments, constraints, such as absolute, hard, and soft constraints can be placed on the variables of the present invention. For example, absolute constraints can be placed on variables, such as tasks, workload eligibility, capacity, and resources availability, to ensure that the values assigned to these variables are not changed or violated. Hard constraints can be used to rank variables so that an absolute constraint or a hard constraint with a higher rank takes precedence over lower ranked variables. Soft constraints can be assigned to variables of lesser importance than variables associated with absolute and hard constraints.

The foregoing description, for purposes of explanation, used specific nomenclature to provide a thorough understanding of the invention. However, it will be apparent to one skilled in the art that the specific details are not required in order to practice the invention. The foregoing description of specific embodiments of the present invention are presented for purposes of illustration and description. They are not intended to be exhaustive or to limit the invention to the precise forms disclosed. Obviously many modifications and variations are possible in view of the above teachings. The embodiments are shown and described in order to best explain the of the invention and its practical applications, to thereby enable others skilled in the art to best utilize the invention and various embodiments with various modifications as are suited to the particular use contemplated. It is intended that the scope of the invention be defined by the following claims and their equivalents:

1. A method for determining a resource schedule, the method comprising:
receiving a set of resources and associated resource data;
determining a resource-rank-function value for each resource, based on the associated resource data;
rank ordering each resource, based on the resource-rank-function value associated with each resource;
determining a set of candidate shifts for each resource, based on the associated resource data;
determining a weight value for the candidate shifts associated with each resource; and
determining a schedule of shifts for each resource in rank order, based on the weight values associated with each candidate shift.

2. The method of claim 1 wherein the associated resource data further includes:
resource availability;
workload eligibility;
qualifications;
costs;
priority;
workload demand; and
importance.

3. The method of claim 2 wherein the workload demand and importance are dependent on time unit increments of a period.

4. The method of claim I wherein determining the resource-rank-function value further includes:
resource priority;
number of tasks a resource can carry out;
total number of tasks available;
maximum resource assignment costs;
maximum overall resource assignment costs;
maximum overall qualification of the resources;
average qualification of a resource; and
total time the resource is already scheduled.

5. The method of claim 1 wherein determining the weight value for each candidate shift further includes determining a weight-list value for each time unit of each workload.

6. The method of claim 5 wherein determining the weight-list value further includes determining qualification cost for each resource.

7. The method of claim 5 wherein determining the weight-list value further includes determining a raw demand for each workload a resource is eligible to perform.

8. The method of claim 7 wherein determining the weight-list value further includes adjusting the raw demand.

9. The method of claim 5 wherein determining the weight-list value for each shift further includes integrating the weight list over each shift.

10. The method of claim 1 wherein determining the weight value for each candidate shift further includes combining shifts to give a single shift.

11. The method of claim 1 wherein determining the schedule of shifts for each resource in rank order further includes beginning with the resource having a lowest resource-rank-function value and ending with the resource having a highest resource-rank-function value.

12. The method of claim 1 wherein determining the schedule of candidate shifts based on the weight values further includes selecting shifts having the largest weight values.

13. The method of claim 1 further includes adjusting resource availability after a resource is scheduled.

14. The method of claim 1 further includes updating resource workload characteristics after a resource is scheduled.

15. The method of claim 1 further includes removing workloads with no associated demand, after a resource is scheduled.

16. A representation of the output data set, produced using the method of claim 1, that is maintained for subsequent analysis by one of:
storing the output schedule in a computer-readable medium; and
transferring the output schedule to an intercommunicating entity via electronic signals.

17. Results produced by a resource scheduling program employing the method of claim 1 stored in a computer-readable medium.

18. Results produced by a resource scheduling processing program employing the method of claim 1 printed in a human-readable format.

19. Results produced by a resource scheduling program employing the method of claim 1 transferred to an intercommunicating entity via electronic signals.

20. A method comprising communicating to a remote location a resource schedule output obtained by a method of claim 1.

21. A method comprising receiving data produced by using the method of claim 1.

22. A system for determining resource schedule, the system comprising:
a computer processor;
a communications medium by which one or more input data sets are received by the resource scheduling data processing system;
a program, stored in the one or more memory components and executed by the computer processor that receives a set of resources and associated resource data; determines a resource-rank-function value for each resource, based on the associated resource data; rank orders each resource, based on the resource-rank-function value associated with each resource; determines a set of candidate shifts for each resource based on the associated resource data; determines a weight value for the candidate shifts associated with each resource; and determines a schedule of shifts for each resource in rank order, based on the weight values associated with each candidate shift.
